(19) United States
(12) Patent Application Publication
(10) Pub. No.: US 2026/0065508 A1
(43) Pub. Date: Mar. 5, 2026

(54) METHOD FOR MEASURING THE DISTANCE BETWEEN EXCAVATOR AND HIGH-VOLTAGE TRANSMISSION LINE

(71) Applicant: Guizhou Power Grid Co., Ltd., Guiyang (CN)

(72) Inventors: Qing LIU, Guiyang (CN); Yi LI, Guiyang (CN); Yu WU, Guiyang (CN); Jibin JIANG, Guiyang (CN); Xiaohu ZHENG, Guiyang (CN); Youjun WANG, Guiyang (CN); Yao ZHANG, Guiyang (CN); Lin LI, Guiyang (CN); Kun ZHANG, Guiyang (CN); Xingyuan QIN, Guiyang (CN); Linlin XIONG, Guiyang (CN); Xianglin ZHU, Guiyang (CN); Yonghong HOU, Guiyang (CN); Gang NIE, Guiyang (CN); Yiping ZHONG, Guiyang (CN); Wei GU, Guiyang (CN); Hongjie LI, Guiyang (CN); Shiwei LI, Guiyang (CN); Pan PAN, Guiyang (CN); Xingdou DAI, Guiyang (CN); Tianying HUANG, Guiyang (CN); Yang SI, Guiyang (CN); Xuemei RAO, Guiyang (CN); Zhanjun LIU, Guiyang (CN); Shuyi ZHENG, Guiyang (CN)

(21) Appl. No.: 19/384,952

(22) Filed: Nov. 10, 2025

Related U.S. Application Data
(63) Continuation of application No. PCT/CN2024/108002, filed on Jul. 26, 2024.

(30) Foreign Application Priority Data
Feb. 29, 2024 (CN) 202410231010.X

(51) Int. Cl. G06T 7/77; G01B 11/00; G01B 11/14; G06T 7/80; G06V 20/52

(52) U.S. Cl. CPC G06T 7/77; G01B 11/002; G01B 11/14; G06T 7/80; G06V 20/52; G06T 2207/30261; G06V 2201/08

(57) ABSTRACT

The present invention discloses a method for measuring the distance between an excavator and a high-voltage transmission line, comprising obtaining camera parameters through the Zhang's Checkerboard calibration method; collecting images, inputting images fully entering the field of view of the camera into a model; obtaining the pixel coordinate of a target frame through the YOLOV5 algorithm; obtaining target world coordinate; analyzing lengths, widths, and heights of 3D models of excavators by using a clustering algorithm, and calculating the geometric mean of each cluster; and measuring the height of the transmission line by a millimeter wave radar, and estimating the height of an object from the steps above, thereby obtaining the distance between the excavator and the high-voltage transmission line.

### CROSS-REFERENCE TO RELATED APPLICATIONS

The present application is a continuation of International Application No. PCT/CN2024/108002, filed on Jul. 26, 2024, and claims priority to Chinese Patent Application No. 202410231010.X, filed on Feb. 29, 2024, the entire disclosure of which is incorporated herein by reference.

### BACKGROUND

With the development of industrialization and the continuous expansion of urban construction, the construction of long-span high-voltage transmission lines and road excavation projects is increasingly frequent. However, the issue of distance between high-voltage transmission lines and excavators always exists, which not only affects the progress of projects, but also poses safety hazards. Therefore, accurately measuring the distance between high-voltage transmission lines and excavators becomes an important technology.

Various methods are commonly used to measure the distance between high-voltage transmission lines and excavators, among which the more common ones are laser ranging and GPS ranging. Laser ranging is a method of measuring distances using a laser beam. By irradiating and reflecting lasers between excavators and high-voltage transmission lines, the distance between two points is measured and position coordinates are determined using lasers and receivers. This method requires good environmental lighting conditions, being high in cost, and the laser is affected by the atmosphere, which in turn affects measurement accuracy. The GPS ranging method generally requires installing a GPS receiver on an excavator, and obtaining the position and direction of rotation of the excavator through interaction with satellite signals, so as to calculate the distance between the excavator and the high-voltage transmission line. But this method requires an area with good satellite signals and a wide field of view, so the feasibility and accuracy of the method are limited by dense buildings and in mountainous areas with dense trees.

Overall, the applicability of the above methods is limited and cannot perform real-time detection, failing to meet the requirement of early warning. The technology for measuring the distance between high-voltage transmission lines and excavators is becoming increasingly mature, but in practical applications, appropriate methods still need to be selected according to different engineering situations, and attention should be paid to the influence of environmental factors to ensure the accuracy of measurement.

### SUMMARY

In view of the existing problems above, the present invention is disclosed.

Therefore, the present invention discloses a method for measuring the distance between an excavator and a high-voltage transmission line, to solve the problems that conventional methods are limited in application scenes, and cannot perform real-time detection, failing to meet the requirement of early warning.

In order to solve the technical problems above, the present invention provides the following technical solutions: a method for measuring the distance between an excavator and a high-voltage transmission line, including:
defining a coordinate system, and marking an existing camera through the Zhang's Checkerboard calibration method so as to obtain an internal parameter matrix and an external parameter matrix of the camera; fixing the installation height of the camera and the tilt angle θ of the camera, measuring the height of the camera from the ground by using an infrared ranging meter, and obtaining the tilt angle θ of the camera through PTZ (Pan, Tilt, Zoom) information of the camera in real time; Detecting images collected by the camera through the YOLOV5 algorithm, detecting and positioning targets in the images, obtaining a rectangular frame of the minimum area of the targets fully entering the field of view of the camera, and calculating depth information of the targets from the camera plane on the basis; classifying the targets into large, medium and small through the partitioning clustering algorithm, analyzing lengths, widths and heights of 3D models of excavators in each category, calculating the geometric mean of each cluster of the excavators, and carrying out overall averaging; and measuring the lowest height of the high-voltage transmission line through a millimeter wave radar, and obtaining the height of the target object and the distance between the high-voltage transmission line and the target through calculation.

As the method for measuring the distance between the excavator and the high-voltage transmission line, defining the coordinate system includes, customizing a world coordinate system, a camera coordinate system, an image coordinate system and a pixel coordinate system.
namely drawing a vertical line from the installation position of the camera to the ground, and establishing the world coordinate system by taking the point on the ground as the origin O_{w} of the world coordinate system, the front perpendicular to the origin O_{w} as the X_{w} axis of the world coordinate system, the right side perpendicular to the origin as the Y_{w} axis of the world coordinate system, and the direction of the origin O_{w} along the camera as the Z_{w} axis;
establishing the camera coordinate system by taking the optical center of the camera as the origin O_{c} of the camera coordinate system, the optical axis of the camera as the positive direction of Z_{c}, the direction directly above the camera as the positive direction of Y_{c}, and the direction directly to the right of the camera as the positive direction of X_{c};
establishing the image coordinate system by taking the imaging plane of the camera and the focus of the optical axis of the camera as the origin O of the image coordinate system, the direction directly below the origin O as the positive direction of the Y axis of the image coordinate system, and the direction directly to the right of the origin O as the positive direction of the X axis of the image coordinate system; and
establishing the pixel coordinate system by taking the direction to the upper left of the image as the origin O₁ of the pixel coordinate system, the direction directly below O₁ as the v axis of the pixel coordinate system, and the direction directly to the right of O₁ as the positive direction of the u axis.

As a preferable solution of the method for measuring the distance between the excavator and the high-voltage transmission line, the pixel coordinate system includes, carrying out camera calibration on the camera so as to obtain an internal parameter matrix A and an external parameter matrix B of the camera:

$$\begin{matrix}A = [ \begin{matrix}{d}_{x} & r & {u}_{0} \\ & {d}_{y} & {v}_{0} \\ & & 1\end{matrix} ] \\ B = [ \begin{matrix}R & T \\ 0 & 1\end{matrix} ]\end{matrix}$$

dₓ and d_{y} indicate scale factors of a pixel at the u axis and the v axis of the pixel coordinate system, corresponding to the focal lengths of the camera, r indicates a distortion factor u₀ of an image physical coordinate, v₀ refers to the pixel offset of the image origin relative to the longitudinal and transverse coordinates of an optical imaging point, R indicates the direction of the coordinate axes of the world coordinate system relative to the coordinate axes of the camera, and T indicates the position of the coordinate origin of the world coordinate system relative to the spatial origin in the camera coordinate system.

As a preferable solution of the method for measuring the distance between the excavator and the high-voltage transmission line, using the infrared ranging meter includes, fixing the installation height of the camera, and measuring the height of the camera relative to the horizontal ground as H by using the infrared ranging meter; controlling the camera to rotate in a vertical direction through software, setting each rotation time as T fixedly, measuring the rotation angle of the camera within the time T as θ by using an angle range finder so as to obtain the rotation speed of the camera within unit time as W=θ/T (°/s), thereby obtaining the deflection angle θ of the camera relative to a horizontal axis in real time.

As a preferable solution of the method for measuring the distance between the excavator and the high-voltage transmission line, detecting and positioning includes, detecting images collected by the camera through the YOLOV5 algorithm, detecting and positioning targets in the images, obtaining the rectangular frame of the minimum area of the targets fully entering the field of view of the camera, taking the midpoint Q at the bottom and the midpoint T at the top of the target frame, when the camera is not tilted, drawing vertical lines from the point Q and the point T to the Ow-Zw-Xw plane to intersect at a point P and a point S, and then, extending the intersection of the point P and the point S with the optical center to form a plane at a point P′ and a point S′, thereby obtaining the pixel coordinate information of Q′ and T′ through the defined coordinate systems:

$$\begin{matrix}{{Q}^{′}}^{} = ( {u}_{1} - \frac{Width}{2} - \frac{Hegiht}{2} - ( {v}_{1} + \frac{h}{2} ) ) \\ {T}^{′} = ( {u}_{1} - \frac{Width}{2} , \frac{Hegiht}{2} - ( {v}_{1} - \frac{h}{2} ) )\end{matrix}$$

width and Height represent the horizontal and vertical resolutions of the image, sizes of which can be set in advance, (u1,v1) are the geometric centers of the target frame, and h is the width of the target frame.
when the deflection angle of the optical axis angle of the camera is θ, first a ground point Q is analyzed, after the previous step, a vertical line is drawn from the point P to the optical axis Z_{c} to intersect the optical axis at a point D, the included angle formed by the line connecting the optical axis and O_{c}D is ∠b, and the vertex angle of the angle is ∠b, the included angle formed by the line connecting the point P and the optical center O_{c} and the line connecting the point P and O_{w} is ∠c, the calculation method for the point T is the same.

As a preferable solution of the method for measuring the distance between the excavator and the high-voltage transmission line, the deflection angle of the optical axis angle of the camera includes, a geometrical relationship including the following relational equation:

$$\begin{matrix}∠ b = ∠ {b}^{′} = arctan ( \frac{{OP}^{′}}{f} ) \\ ∠ c = ∠θ + ∠ b \\ {O}_{c} P = \frac{H}{sin ( ∠ c )} \\ {O}_{c} D = {O}_{c} P * cos ( ∠ b )\end{matrix}$$

the relationship between the pixel coordinate system and the world coordinate system obtained is as follows:

$$[ \begin{matrix}{x}_{w} \\ {y}_{w} \\ {z}_{w} \\ 1\end{matrix} ] = {B}^{- 1} {A}^{- {1}_{{z}_{c}}} [ \begin{matrix}u \\ v \\ 1\end{matrix} ]$$

in the equation, Z_{c}=O_{c}D, A⁻¹ indicates an inverse A matrix of the internal parameter matrix, and B⁻¹ is an inverse matrix of the external parameter matrix of the camera.

As a preferable solution of the method for measuring the distance between the excavator and the high-voltage transmission line, classifying the targets into large, medium and small through the partitioning clustering algorithm includes, analyzing lengths, widths and heights of 3D models of different categories of excavators through the K-Means clustering algorithm, calculating the geometric mean of each cluster of the excavators, and calculating the overall mean of the averaging so as to obtain O_{_L},O_{_K},O_{_H} of the target. The K-Means clustering algorithm specifically includes the following steps:
inputting a sample set D={X1, X2, X3, . . . Xm}, the number of clusters K=3, representing the large, medium and small categories respectively;
randomly selecting K samples from the sample set D as an initial mean vector {μ₁,μ₂,μ₃};
setting Cᵢ=Ø(1≤i≤K), and calculating the distance

$${d}_{ji} = {‖ {x}_{j} - {μ}_{i} ‖}_{2}$$

between each sample xⱼ and the mean vector

$${μ}_{i} ( 1 \leq i \leq K ) ;$$

determining a cluster label

$${λ}_{j} = arg {min}_{i ∈ \{ 1 , 2 , 3 \}} {d}_{ji}$$

of xⱼ based on the mean vector in the nearest distance, and assigning xⱼ into a corresponding cluster

$${C}_{{λ}_{j}} = {C}_{{λ}_{j}} ⋃ \{ {x}_{j} \} ;$$

calculating a new mean vector

$${μ}_{i}^{′} = \frac{1}{\vert {C}_{i} \vert} {\sum }_{x ∈ {C}_{i}} x ;$$

judging whether the updated vector is equal to a current mean μᵢ or not; if not, assigning μ′ᵢ to μᵢ; if so, quitting updating the mean; repeating the above steps until small change in the mean, thereby completing classification;
outputting cluster classification

$$C = \{ {C}_{1} , {C}_{2} , {C}_{3} \} ,$$

wherein each C represents a three-dimensional vector respectively substituted into the length, width and height of the excavator, and carrying out overall averaging on the length, width and height of three categories so as to obtain a final output Y=[O_{_L},O_{_K},O_{_H}];
carrying out posture analysis on the target, first defining a cuboid with the length W_{Anchor}, the width l_{Anchor}, and the height h_{Anchor} to enclose the target; from the top view, analyzing the included angle formed between the target and the cuboid as O, thereby obtaining the following equation:

$${O}_{\_ L} * cos ω + {O}_{\_ K} * sin ω = {W}_{Anchor}$$

$${O}_{\_ L} * sin ω + {O}_{\_ K} * cos ω = {l}_{Anchor}$$

in the equation, calculating W_{Anchor} according to the actual length of the length of the target frame in the world coordinate system, setting the lower left corner of the target frame as a point M and the lower right corner a point K so as to obtain coordinates of the point M and the point K in the pixel coordinate system as follows:

$${M}^{′} = ( {u}_{1} - \frac{Width}{2} - \frac{w}{2} , \frac{Hegiht}{2} - ( {v}_{1} + \frac{h}{2} ) )$$

$${K}^{′} = ( {u}_{1} - \frac{Width}{2} + \frac{w}{2} , \frac{Hegiht}{2} - ( {v}_{1} + \frac{h}{2} ) )$$

obtaining the world coordinate of the point M and the point K:

$$M = ( {X}_{m} , {Y}_{m} , {Z}_{m} )$$

$$K = ( {X}_{k} , {Y}_{k} , {Z}_{k} )$$

thereby obtaining:

$${W}_{Anchor} = \vert {X}_{m} - {X}_{k} \vert$$

in the equation, O_{_L} and O_{_H} are obtained by simplifying

$$cos w = \sqrt{1 - {sin}^{2} w} ;$$

$$( {O}_{\_ L}^{2} + {O}_{\_ K}^{2} ) * {sin}^{2} w - 2 {O}_{\_ L} * {W}_{Anchor} sin w + ( {W}_{Anchor}^{2} - {O}_{\_ K} ) = 0$$

setting

$$a = {O}_{\_ L}^{2} + {O}_{\_ K}^{2} and b = - 2 {O}_{\_ L} * {W}_{Anchor} ,$$

and obtaining

$$b = - 2 {O}_{\_ L} * {W}_{Anchor}$$

through a quadratic formula:
from

$$0 ° \leq ω \leq \frac{π}{2} ,$$

sin ω is a positive value:

$$sin ω = \vert \frac{- b \pm \sqrt{{b}^{2} \to 4 a c}}{2 a} \vert$$

$$ω = arcsin \vert \frac{- b \pm \sqrt{{b}^{2} - 4 ac}}{2 a} \vert$$

substituting ω into the equation, thereby obtain:

$${l}_{Anchor} = {O}_{\_ L} * sin ω + {O}_{\_ K} * cos ω .$$

As a preferable solution of the method for measuring the distance between the excavator and the high-voltage transmission line, the height of the target object and the distance between the high-voltage transmission line and the target comprises, measuring the height of the high-voltage transmission line as

$${H}_{wrie}$$

by using the millimeter wave radar; according to the length O_{_L}, width O_{_K} and O_{_H} of the target after clustering, establishing a three-dimensional cube of the target; corresponding the point Q to the point G at the top of the target cube; connecting the optical center O_{c} with the point T to intersect a point S at the back of the cube; forming an included angle γ by O_{c}-T-S and the horizontal plane; and setting the length of GT as

$${h}_{x} ,$$

thereby obtaining the following equation according to the geometrical relationship:

$$tan γ = \frac{{h}_{x}}{{l}_{anchor}}$$

$$tan γ = \frac{H - h}{{D}_{OwQ} + {l}_{anchor}}$$

$${h}_{object} = {h}_{Anchor} - h$$

wherein,

$${h}_{Anchor}$$

is the coordinate Z

$${D}_{OwQ} = \sqrt{{X}_{wQ}^{2} + {Y}_{wQ}^{2}}$$

of the point T in the world coordinate system, the height of the object is estimated by integrating the target position and the posture information, and thus the distance between the excavator and the high-voltage transmission line is further obtained:

$$distacnce = {H}_{wrie} - {h}_{object} .$$

A computer device, including: a memory and a processor; the memory is used for storing computer programs; and the steps of the method for measuring the distance between the excavator and the high-voltage transmission line are achieved when the computer programs are executed by the processor.

A computer readable storage medium, with computer programs stored thereon; and the steps of the method for measuring the distance between the excavator and the high-voltage transmission line are achieved when the computer programs are executed by the processor.

The present invention has the beneficial effects that:
1. Simple to operate and economic and efficient: camera calibration, image filtering and algorithm analysis are carried out through the Zhang's Checkerboard calibration method, making the measurement process simple, and due to adoption of relatively simple devices, the present invention is low in cost.

Ideal in measurement precision: with the combination of imaging models of the camera and clustering algorithm, the height of the power transmission line is measured through the millimeter wave radar, the height of the object is further estimated, and thus precise measurement on the distance between the excavator and the power transmission line is achieved.

High in transferability: the method of the present invention is applicable to distance measurement between excavators and power transmission lines in different environments, being easy to port and use.

### BRIEF DESCRIPTION OF DRAWINGS

In order to describe the technical solutions in the examples of the present disclosure more clearly, a brief description of the accompanying drawings required for describing the examples will be provided below. Obviously, the accompanying drawings in the following description show merely some examples of the present disclosure. Those of ordinary skill in the art can also derive other accompanying drawings from these accompanying drawings without making creative efforts.

FIG. 1 is a process diagram of the method for measuring the distance between the excavator and the high-voltage transmission line provided by an embodiment of the present invention;

FIG. 2 is a schematic diagram of coordinate systems of the method for measuring the distance between the excavator and the high-voltage transmission line provided by an embodiment of the present invention;

FIG. 3 is an analytical schematic diagram of the camera without tilt angle of the method for measuring the distance between the excavator and the high-voltage transmission line provided by an embodiment of the present invention;

FIG. 4 is an analytical schematic diagram of the camera with tilt angle of the method for measuring the distance between the excavator and the high-voltage transmission line provided by an embodiment of the present invention;

FIG. 5 is an analytical schematic diagram of the planar posture of the target of the method for measuring the distance between the excavator and the high-voltage transmission line provided by an embodiment of the present invention; and

FIG. 6 is an analytical schematic diagram of three-position posture of the target of the method for measuring the distance between the excavator and the high-voltage transmission line provided by an embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. Apparently, the described embodiments are only part of the embodiments of the present invention, not all of them. On the basis of the examples of the present invention, all other examples obtained by those of ordinary skill in the art without creative efforts shall fall within the protection scope of the present invention.

A number of specific details are set forth in the description below to provide a thorough understanding for the present invention, however, the present invention may also be implemented in other manners different from those described herein, and those skilled in the art may make similar generalization without departing from the essence of the present invention, therefore, the present invention is not limited by the specific examples disclosed below.

Secondly, reference herein to “an example” or “example” means a specific feature, structure, or characteristic that can be included in at least one embodiment of the present disclosure. The term “in one example” appearing at different positions in the present specification does not necessarily refer to the same example, nor is it a separate or selective example that is mutually exclusive to other examples.

The present invention is described in detail in conjunction with schematic diagrams. For the purpose of description, sectional views of the device structure are partially enlarged without being drawn to scale. The schematic diagrams are merely exemplary and should not limit the protection scope of the present invention. Furthermore, it is important to consider the three-dimensional spatial dimensions of length, width, and depth in actual production.

It should be noted that in the description of the present invention that terms such as “up, down, inside, and outside” indicating orientation or positional relationships are based on the orientation or positional relationships shown in the illustrations for the purpose of facilitating the description and simplifying the disclosure. They do not indicate or imply that the device or the components referred to must have a specific orientation, be constructed in a specific orientation, or operate in a specific orientation, and therefore should not be construed as limiting the present invention. In addition, the terms “first, second or third” are only adopted for describing purposes and should not be understood to indicate or imply relative importance.

In the present invention, unless otherwise definitely specified and limited, terms “install, mutually connect and connect” should be broadly understood. For example, the terms may refer to fixed connection, detachable connection or integration, may also refer to mechanical connection, electrical connection or direct connection, may also refer to indirect connection through a medium, and may also be internal communication of two elements. The terms described above have specific meanings in the present invention that can be understood by those skilled in the art in light of the particular circumstances.

### Embodiment 1

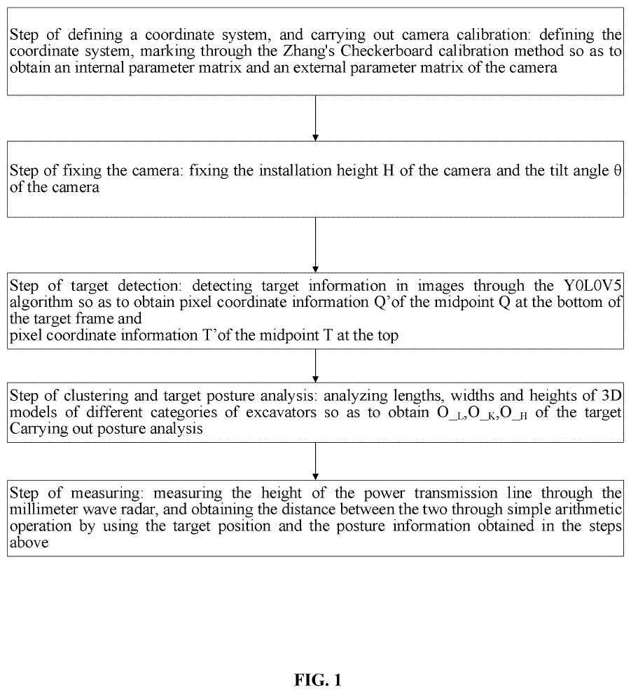

Referring to FIG. 1, as a first embodiment of the present invention, the embodiment provides a method for measuring the distance between an excavator and a high-voltage transmission line, including.
defining a coordinate system, and marking an existing camera through the Zhang's Checkerboard calibration method so as to obtain an internal parameter matrix and an external parameter matrix of the camera; fixing the installation height of the camera and the tilt angle θ of the camera, measuring the height of the camera from the ground by using an infrared ranging meter, and obtaining the tilt angle θ of the camera through PTZ (Pan, Tilt, Zoom) information of the camera in real time; Detecting images collected by the camera through the YOLOV5 algorithm, detecting and positioning targets in the images, obtaining a rectangular frame of the minimum area of the targets fully entering the field of view of the camera, and calculating depth information of the targets from the camera plane on the basis; classifying the targets into large, medium and small through the partitioning clustering algorithm, analyzing lengths, widths and heights of 3D models of excavators in each category, calculating the geometric mean of each cluster of the excavators, and carrying out overall averaging; and measuring the lowest height of the high-voltage transmission line through a millimeter wave radar, and obtaining the height of the target object and the distance between the high-voltage transmission line and the target through calculation.

Defining the coordinate system includes, customizing a world coordinate system, a camera coordinate system, an image coordinate system and a pixel coordinate system.

Drawing a vertical line from the installation position of the camera to the ground, and establishing the world coordinate system by taking the point on the ground as the origin O_{w} of the world coordinate system, the front perpendicular to the origin O_{w} as the X_{w} axis of the world coordinate system, the right side perpendicular to the origin as the Y_{w} axis of the world coordinate system, and the direction of the origin O_{w} along the camera as the Z_{w} axis.

Establishing the camera coordinate system by taking the optical center of the camera as the origin O_{c} of the camera coordinate system, the optical axis of the camera as the positive direction of Z_{c}, the direction directly above the camera as the positive direction of Y_{c}, and the direction directly to the right of the camera as the positive direction of X_{c}.

Establishing the image coordinate system by taking the imaging plane of the camera and the focus of the optical axis of the camera as the origin O of the image coordinate system, the direction directly below the origin O as the positive direction of the Y axis of the image coordinate system, and the direction directly to the right of the origin O as the positive direction of the X axis of the image coordinate system.

establishing the pixel coordinate system by taking the direction to the upper left of the image as the origin O₁ of the pixel coordinate system, the direction directly below O₁ as the v axis of the pixel coordinate system, and the direction directly to the right of O₁ as the positive direction of the u axis.

Carrying out camera calibration on the camera so as to obtain an internal parameter matrix A and an external parameter matrix B of the camera.

$$A = [ \begin{matrix}{d}_{x} & r & {u}_{0} \\ & {d}_{y} & {v}_{0} \\ & & 1\end{matrix} ]$$

$$B = [ \begin{matrix}R & T \\ 0 & 1\end{matrix} ]$$

dₓ and d_{y} indicate scale factors of a pixel at the u axis and the v axis of the pixel coordinate system, corresponding to the focal lengths of the camera, r indicates a distortion factor u₀ of an image physical coordinate, v₀ refers to the pixel offset of the image origin relative to the longitudinal and transverse coordinates of an optical imaging point, R indicates the direction of the coordinate axes of the world coordinate system relative to the coordinate axes of the camera, and T indicates the position of the coordinate origin of the world coordinate system relative to the spatial origin in the camera coordinate system.

Fixing the installation height of the camera, and measuring the height of the camera relative to the horizontal ground as H by using the infrared ranging meter; controlling the camera to rotate in a vertical direction through software, setting each rotation time as T fixedly, measuring the rotation angle of the camera within the time T as θ by using an angle range finder so as to obtain the rotation speed of the camera within unit time as W=θ/T (°/s), thereby obtaining the deflection angle θ of the camera relative to a horizontal axis in real time.

Detecting images collected by the camera through the YOLOV5 algorithm, detecting and positioning targets in the images, obtaining the rectangular frame of the minimum area of the targets fully entering the field of view of the camera, taking the midpoint Q at the bottom and the midpoint T at the top of the target frame, when the camera is not tilted, drawing vertical lines from the point Q and the point T to the Ow-Zw-Xw plane to intersect at a point P and a point S, and then, extending the intersection of the point P and the point S with the optical center to form a plane at a point P′ and a point S′, thereby obtaining the pixel coordinate information of Q′ and T′ through the defined coordinate systems.

$${Q}^{′} = ( {u}_{1} - \frac{Width}{2} , \frac{Hegiht}{2} - ( {v}_{1} + \frac{h}{2} ) )$$

$${T}^{′} = ( {u}_{1} - \frac{Width}{2} , \frac{Hegiht}{2} - ( {v}_{1} - \frac{h}{2} ) )$$

Width and Height represent the horizontal and vertical resolutions of the image, sizes of which can be set in advance, (u1,v1) are the geometric centers of the target frame, and h is the width of the target frame.
when the deflection angle of the optical axis angle of the camera is θ, first a ground point Q is analyzed, after the previous step, a vertical line is drawn from the point P to the optical axis Z_{c} to intersect the optical axis at a point D, the included angle formed by the line connecting the optical axis and O_{c}D is ∠b, and the vertex angle of the angle is ∠b, the included angle formed by the line connecting the point P and the optical center O_{c} and the line connecting the point P and O_{w} is ∠c, the calculation method for the point T is the same.

The geometric relationships include the following retional equations:

$$∠ b = ∠ {b}^{′} = arc tan ( \frac{{OP}^{′}}{f} )$$

$$∠ c = ∠ θ + ∠ b$$

$${O}_{c} P = \frac{H}{sin ( ∠ c )}$$

$${O}_{c} D = {O}_{c} P * cos ( ∠ b )$$

the relationship between the pixel coordinate system and the world coordinate system obtained is as follows:

$$[ \begin{matrix}{x}_{w} \\ {y}_{w} \\ {z}_{w} \\ 1\end{matrix} ] = {B}^{- 1} {A}^{- {1}_{{z}_{c}}} [ \begin{matrix}u \\ v \\ 1\end{matrix} ]$$

in the equation, Z_{c}=O_{c}D, A⁻¹ indicates an inverse A matrix of the internal parameter matrix, and B⁻¹ is an inverse matrix of the external parameter matrix of the camera.

Analyzing lengths, widths and heights of 3D models of different categories of excavators through the K-Means clustering algorithm, calculating the geometric mean of each cluster of the excavators, and calculating the overall mean of the averaging so as to obtain O_{_L},O_{_K},O_{_H} of the target. The K-Means clustering algorithm specifically includes the following steps:
inputting a sample set D={X1,X2,X3, . . . Xm}, the number of clusters K=3, representing the large, medium and small categories respectively;
randomly selecting K samples from the sample set D as an initial mean vector {μ₁,μ₂,μ₃};
setting Cᵢ=Ø(1≤i≤K), and calculating the distance

$${d}_{ji} = {‖ {x}_{j} - {μ}_{i} ‖}_{2}$$

between each sample xⱼ and the mean vector

$${μ}_{i} ( 1 \leq i \leq K ) ;$$

determining a cluster label

$${λ}_{j} = arg {min}_{i ∈ \{ 1 , 2 , 3 \}} {d}_{ji}$$

of xⱼ based on the mean vector in the nearest distance, and assigning xⱼ into a corresponding cluster

$${C}_{{λ}_{j}} = {C}_{{λ}_{j}} ⋃ \{ {x}_{j} \} ;$$

calculating a new mean vector

$${μ}_{i}^{′} = \frac{1}{\vert {C}_{i} \vert} {\sum }_{x ∈ {C}_{i}} x ;$$

judging whether the updated vector is equal to a current mean p, or not; if not, assigning μ′ᵢ to μᵢ; if so, quitting updating the mean; repeating the above steps until small change in the mean, thereby completing classification;
outputting cluster classification

$$C = \{ {C}_{1} , {C}_{2} , {C}_{3} \} ,$$

wherein each C represents a three-dimensional vector respectively substituted into the length, width and height of the excavator, and carrying out overall averaging on the length, width and height of three categories so as to obtain a final output Y=[O_{_L},O_{_K},O_{_H}];
carrying out posture analysis on the target, first defining a cuboid with the length W_{Anchor}, the width l_{Anchor}, and the height h_{Anchor} to enclose the target; from the top view, analyzing the included angle formed between the target and the cuboid as ω, thereby obtaining the following equation:

$${O}_{\_ L} * cos ω + {O}_{\_ K} * sin ω = {W}_{Anchor}$$

$${O}_{\_ L} * sin ω + {O}_{\_ K} * cos ω = {l}_{Anchor}$$

in the equation, calculating W_{Anchor} according to the actual length of the length of the target frame in the world coordinate system, setting the lower left corner of the target frame as a point M and the lower right corner a point K so as to obtain coordinates of the point M and the point K in the pixel coordinate system as follows:

$${M}^{′} = ( {u}_{1} - \frac{Width}{2} - \frac{w}{2} , \frac{Hegiht}{2} - ( {v}_{1} + \frac{h}{2} ) )$$

$${K}^{′} = ( {u}_{1} - \frac{Width}{2} - \frac{w}{2} , \frac{Hegiht}{2} - ( {v}_{1} + \frac{h}{2} ) )$$

obtaining the world coordinate of the point M and the point K:

$$M = ( {X}_{m} , {Y}_{m} , {Z}_{m} )$$

$$K = ( {X}_{k} , {Y}_{k} , {Z}_{k} )$$

thereby obtaining:

$${W}_{Anchor} = \vert {X}_{m} - {X}_{k} \vert$$

in the equation, O_{_L} and O_{_H} are obtained by simplifying

$$cos w = \sqrt{1 - {sin}^{2} w} ;$$

$$( {O}_{\_ L}^{2} + {O}_{\_ K}^{2} ) * {sin}^{2} w - 2 {O}_{\_ L} * {W}_{Anchor} sin w + ( {W}_{Anchor}^{2} - {O}_{\_ K} ) = 0$$

setting

$$a = {O}_{\_ L}^{2} + {O}_{\_ K}^{2} and b = - 2 {O}_{\_ L} * {W}_{Anchor} ,$$

and obtaining

$$b = - 2 {O}_{\_ L} * {W}_{Anchor}$$

through a quadratic formula:
from

$$0 ° \leq ω \leq \frac{π}{2} ,$$

sin ω is a positive value:

$$sin ω = \vert \frac{- b \pm \sqrt{{b}^{2} \to 4 a c}}{2 a} \vert$$

$$ω = arcsin \vert \frac{- b \pm \sqrt{{b}^{2} - 4 ac}}{2 a} \vert$$

substituting co into the equation, thereby obtain:

$${l}_{Anchor} = {O}_{\_ L} * sin ω + {O}_{\_ K} * cos ω .$$

Measuring the height of the high-voltage transmission line as

$${H}_{wrie}$$

by using the millimeter wave radar; according to the length O_{_L}, width O_{_K} and O_{_H} of the target after clustering, establishing a three-dimensional cube of the target; corresponding the point Q to the point G at the top of the target cube; connecting the optical center O_{c} with the point T to intersect a point S at the back of the cube; forming an included angle γ by O_{c}-T-S and the horizontal plane; and setting the length of GT as

$${h}_{x} ,$$

thereby obtaining the following equation according to the geometrical relationship:

$$tan γ = \frac{{h}_{x}}{{l}_{anchor}}$$

$$tan γ = \frac{H - h}{{D}_{OwQ} + {l}_{anchor}}$$

$${h}_{object} = {h}_{Anchor} - h$$

wherein,

$${h}_{Anchor}$$

is the coordinate Z

$${D}_{OwQ} = \sqrt{{X}_{wQ}^{2} + {Y}_{wQ}^{2}}$$

of the point T in the world coordinate system, the height of the object is estimated by integrating the target position and the posture information, and thus the distance between the excavator and the high-voltage transmission line is further obtained:

$$distacnce = {H}_{wrie} - {h}_{object} .$$

### Embodiment 2

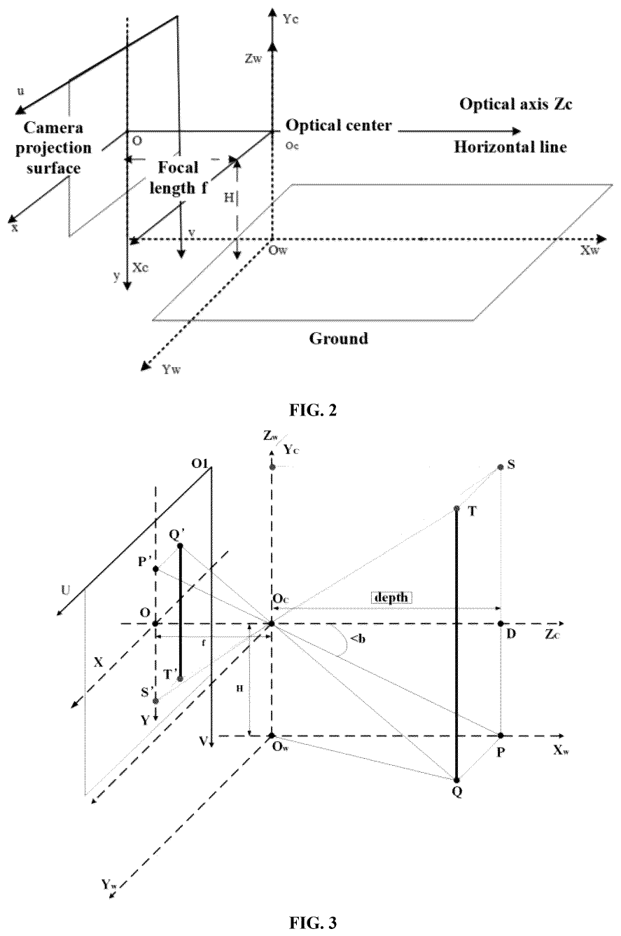

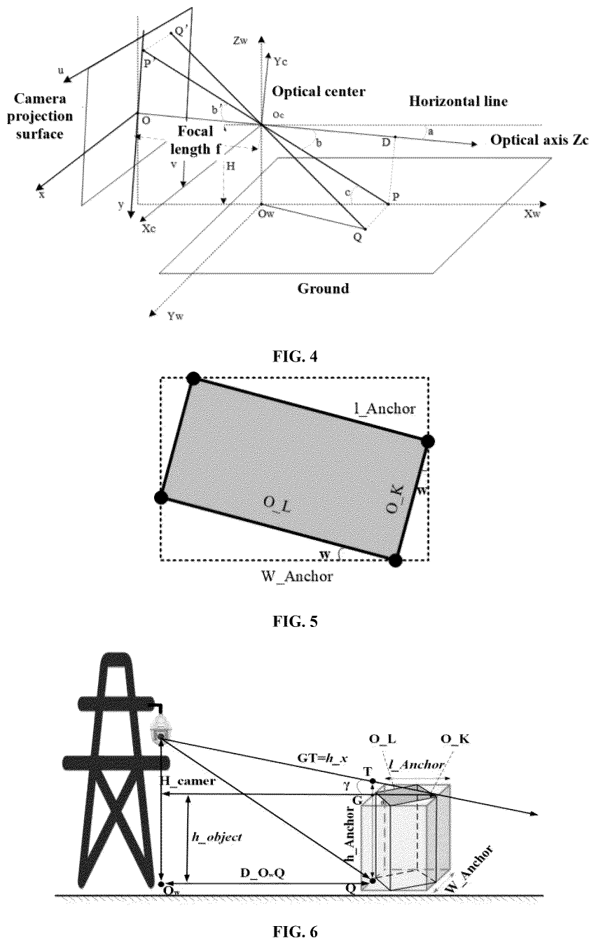

Referring to FIG. 1 to FIG. 6, as an embodiment of the present invention, a method for measuring the distance between an excavator and a high-voltage transmission line is provided. To verify the beneficial effect of the present invention, scientific demonstration is carried out through simulation experiments.

Situation 1: When the height of the camera H=2.0717 m and the tilt angle θ=4°, the height of the excavator measured is 3.18 m, and the actual height of the excavator is 3m. The height of the power transmission line measured is 9.5 m, and the final distance is 6.32 m, with the error being 0.18m.

Situation 2: When the height of the camera H=2.0717 m and the tilt angle θ=12°, the height of the excavator measured is 3.12 m, and the actual height of the excavator is 3m. The height of the power transmission line measured is 9.5 m, and the final distance is 6.38 m, with the error being 0.12m.

Situation 3: When the height of the camera H=2.221 m and the tilt angle θ=4°, the height of the excavator measured is 3.22 m, and the actual height of the excavator is 3m. The height of the power transmission line measured is 9.5 m, and the final distance is 6.28 m, with the error being 0.22m.

It should be noted that the above examples are merely used to explain the technical solutions of the present disclosure and not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

### Embodiment 3

A third embodiment of the present invention is different from the front two embodiments in that:

If a function is implemented in a form of a software functional unit, and sold or used as an independent product, the function may be stored in a computer-readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage medium includes: a USB flash disk, a mobile hard disk, a read-only memory (ROM, Read-Only Memory), a random access memory (RAM, Random Access Memory), a magnetic disk or an optical disk and another medium that can store program codes.

Those skilled in the art should understand that the embodiments of the present application can be provided as methods, systems, or computer program products. Therefore, the present application can take the form of embodiments of full hardwares, full softwares, or a combination of both softwares and hardwares. Moreover, the present application can be implemented in the form of a computer program product that is stored on one or more computer-readable storage media (including but not limited to disk storage, CD-ROM, optical storage, etc.) that contain computer-executable program codes. The solutions described in the embodiments of the present application can be implemented using various computer languages, such as object-oriented programming language Java and direct translation scripting language JavaScript.

The present application is described in reference to the flowcharts and/or block diagrams of the methods, devices (systems), and computer program products according to the embodiments of the present application. It should be understood that each process and/or box in the flowchart and/or block diagram, as well as the combination of processes and/or boxes in the flowchart and/or block diagram, can be implemented by computer program instructions. These computer program instructions can be provided to the processors of general-purpose computers, special-purpose computers, embedded processors or other programmable data processing devices to generate a machine, to enable the execution of the instructions by the processors of computers or other programmable data processing devices to produce a device that realizes the functions specified in a flowchart for one process or multiple processes, and/or in a block diagram for one block or multiple blocks.

These computer program instructions can also be stored in a computer-readable memory that can guide a computer or other programmable data processing device to work in a specific manner, so that the instructions stored in the computer-readable memory generate a product including an instruction device, where the instruction device implements functions specified in one or more processes in the flowcharts and/or one or more blocks in the block diagrams.

These computer program instructions can also be loaded onto computers or other programmable data processing devices, to enable a series of operation steps to be executed on the computer or other programmable device to generate the processing implemented by the computer, thereby the instructions executed on the computer or other programmable device provide steps for implementing the functions specified in a flowchart one process or multiple processes and/or in a block diagram one block or multiple blocks.

Although the preferred embodiments of the present application have been described, those skilled in the art can make additional changes and modifications to these embodiments once grasping the basic creative concept. Therefore, the appended claims are intended to cover all the preferred embodiments as well as all the variations and modifications falling within the scope of the present application.

Obviously, those skilled in the art can make various modifications and variations to the present application without departing from the spirit and scope of the present application. In this way, if these modifications and variations of the present application fall within the scope of the claims of the present application and its equivalents, the present application also intends to include these alterations and variations.

What is claimed is:

1. A method for measuring the distance between an excavator and a high-voltage transmission line, comprising:
defining a coordinate system, and marking an existing camera through the Zhang's Checkerboard calibration method so as to obtain an internal parameter matrix and an external parameter matrix of the camera;
fixing the installation height of the camera and the tilt angle θ of the camera, measuring the height of the camera from the ground by using an infrared ranging meter, and obtaining the tilt angle θ of the camera through PTZ (Pan, Tilt, Zoom) information of the camera in real time;
detecting images collected by the camera through the YOLOV5 algorithm, detecting and positioning targets in the images, obtaining a rectangular frame of the minimum area of the targets fully entering the field of view of the camera, and calculating depth information of the targets from the camera plane on the basis;
classifying the targets into large, medium and small through the partitioning clustering algorithm, analyzing lengths, widths and heights of 3D models of excavators in each category, calculating the geometric mean of each cluster of the excavators, and carrying out overall averaging; and
measuring the lowest height of the high-voltage transmission line through a millimeter wave radar, and obtaining the height of the target object and the distance between the high-voltage transmission line and the target through calculation.

2. The method for measuring the distance between the excavator and the high-voltage transmission line according to claim 1, wherein defining the coordinate system comprises, customizing a world coordinate system, a camera coordinate system, an image coordinate system and a pixel coordinate system;
namely drawing a vertical line from the installation position of the camera to the ground, and establishing the world coordinate system by taking the point on the ground as the origin O_{w} of the world coordinate system, the front perpendicular to the origin O_{w} as the X_{w} axis of the world coordinate system, the right side perpendicular to the origin as the Y_{w} axis of the world coordinate system, and the direction of the origin O_{w} along the camera as the Z_{w} axis;
establishing the camera coordinate system by taking the optical center of the camera as the origin O_{c} of the camera coordinate system, the optical axis of the camera as the positive direction of Z_{c}, the direction directly above the camera as the positive direction of Y_{c}, and the direction directly to the right of the camera as the positive direction of X_{c};
establishing the image coordinate system by taking the imaging plane of the camera and the focus of the optical axis of the camera as the origin O of the image coordinate system, the direction directly below the origin O as the positive direction of the Y axis of the image coordinate system, and the direction directly to the right of the origin O as the positive direction of the X axis of the image coordinate system; and
establishing the pixel coordinate system by taking the direction to the upper left of the image as the origin O₁ of the pixel coordinate system, the direction directly below O₁ as the v axis of the pixel coordinate system, and the direction directly to the right of O₁ as the positive direction of the u axis.

3. The method for measuring the distance between the excavator and the high-voltage transmission line according to claim 2, wherein the pixel coordinate system comprises, carrying out camera calibration on the camera so as to obtain an internal parameter matrix A and an external parameter matrix B of the camera;
$$A = [ \begin{matrix}{d}_{x} & r & {u}_{0} \\ & {d}_{y} & {v}_{0} \\ & & 1\end{matrix} ]$$
$$B = [ \begin{matrix}R & T \\ 0 & 1\end{matrix} ]$$
dₓ and d_{y} indicate scale factors of a pixel at the u axis and the v axis of the pixel coordinate system, corresponding to the focal lengths of the camera, r indicates a distortion factor u₀ of an image physical coordinate, v₀ refers to the pixel offset of the image origin relative to the longitudinal and transverse coordinates of an optical imaging point, R indicates the direction of the coordinate axes of the world coordinate system relative to the coordinate axes of the camera, and T indicates the position of the coordinate origin of the world coordinate system relative to the spatial origin in the camera coordinate system.

4. The method for measuring the distance between the excavator and the high-voltage transmission line according to claim 3, wherein using the infrared ranging meter comprises, fixing the installation height of the camera, and measuring the height of the camera relative to the horizontal ground as H by using the infrared ranging meter; controlling the camera to rotate in a vertical direction through software, setting each rotation time as T fixedly, measuring the rotation angle of the camera within the time T as θ by using an angle range finder so as to obtain the rotation speed of the camera within unit time as W=θ/T (°/s), thereby obtaining the deflection angle θ of the camera relative to a horizontal axis in real time.

5. The method for measuring the distance between the excavator and the high-voltage transmission line according to claim 4, wherein detecting and positioning comprises, detecting images collected by the camera through the YOLOV5 algorithm, detecting and positioning targets in the images, obtaining the rectangular frame of the minimum area of the targets fully entering the field of view of the camera, taking the midpoint Q at the bottom and the midpoint T at the top of the target frame, when the camera is not tilted, drawing vertical lines from the point Q and the point T to the Ow-Zw-Xw plane to intersect at a point P and a point S, and then, extending the intersection of the point P and the point S with the optical center to form a plane at a point P′ and a point S′, thereby obtaining the pixel coordinate information of Q′ and T′ through the defined coordinate systems;
$${Q}^{′} = ( {u}_{1} - \frac{Width}{2} , \frac{Hegiht}{2} - ( {v}_{1} + \frac{h}{2} ) )$$
$${T}^{′} = ( {u}_{1} - \frac{Width}{2} , \frac{Hegiht}{2} - ( {v}_{1} - \frac{h}{2} ) )$$
width and Height represent the horizontal and vertical resolutions of the image, sizes of which can be set in advance, (u1,v1) are the geometric centers of the target frame, and h is the width of the target frame,
when the deflection angle of the optical axis angle of the camera is θ, first a ground point Q is analyzed, after the previous step, a vertical line is drawn from the point P to the optical axis Z_{c} to intersect the optical axis at a point D, the included angle formed by the line connecting the optical axis and O_{c}D is ∠b, and the vertex angle of the angle is ∠b, the included angle formed by the line connecting the point P and the optical center O_{c} and the line connecting the point P and O_{w} is ∠c, the calculation method for the point T is the same.

6. The method for measuring the distance between the excavator and the high-voltage transmission line according to claim 5, wherein the deflection angle of the optical axis angle of the camera comprises, a geometrical relationship including the following relational equation:
$$∠ b = ∠ b = arc tan ( \frac{OP}{f} )$$
$$∠ c = ∠ θ + ∠ b$$
$${O}_{c} P = \frac{H}{sin ( ∠ c )}$$
$${O}_{c} D = {O}_{c} P * cos ( ∠ b )$$
the relationship between the pixel coordinate system and the world coordinate system obtained is as follows:
$$[ \begin{matrix}{x}_{w} \\ {y}_{w} \\ {z}_{w} \\ 1\end{matrix} ] = {B}^{- 1} {A}^{- 1} {z}_{c} [ \begin{matrix}u \\ v \\ 1\end{matrix} ]$$
in the equation, Z_{c}=O_{c}D, A⁻¹ indicates an inverse A matrix of the internal parameter matrix, and B⁻¹ is an inverse matrix of the external parameter matrix of the camera.

7. The method for measuring the distance between the excavator and the high-voltage transmission line according to claim 6, wherein classifying the targets into large, medium and small through the partitioning clustering algorithm comprises, analyzing lengths, widths and heights of 3D models of different categories of excavators through the K-Means clustering algorithm, calculating the geometric mean of each cluster of the excavators, and calculating the overall mean of the averaging so as to obtain O_{_L},O_{_K},O_{_H} of the target, the K-Means clustering algorithm specifically comprises the following steps:
inputting a sample set D={X1,X2,X3, . . . Xm}, the number of clusters K=3, representing the large, medium and small categories respectively;
randomly selecting K samples from the sample set D as an initial mean vector {μ₁,μ₂,μ₃};
setting Cᵢ=Ø(1≤i≤K), and calculating the distance
$${d}_{ji} = {‖ {x}_{j} - {μ}_{i} ‖}_{2}$$
between each sample xⱼ and the mean vector
$${μ}_{i} ( 1 \leq i \leq K ) ;$$
determining a cluster label
$${λ}_{j} = arg {min}_{i ∈ \{ 1 , 2 , 3 \}} {d}_{ji}$$
of xⱼ based on the mean vector in the nearest distance, and assigning xⱼ into a corresponding cluster
$${C}_{{λ}_{j}} = {C}_{{λ}_{j}} ⋃ \{ {x}_{j} \} ;$$
calculating a new mean vector
$${μ}_{i}^{′} = \frac{1}{\vert C \vert} {\sum }_{x ∈ {C}_{i}} x ;$$
judging whether the updated vector is equal to a current mean μᵢ or not; if not, assigning μ′ᵢ to μᵢ; if so, quitting updating the mean; repeating the above steps until small change in the mean, thereby completing classification;
outputting cluster classification
$$C = \{ {C}_{1} , {C}_{2} , {C}_{3} \} ,$$
wherein each C represents a three-dimensional vector respectively substituted into the length, width and height of the excavator, and carrying out overall averaging on the length, width and height of three categories so as to obtain a final output Y=[O_{_L},O_{_K},O_{_H}];
carrying out posture analysis on the target, first defining a cuboid with the length W_{Anchor}, the width l_{Anchor}, and the height h_{Anchor} to enclose the target; from the top view, analyzing the included angle formed between the target and the cuboid as ω, thereby obtaining the following equation:
$${O}_{\_ L} * cos ω + {O}_{\_ K} * sin ω = {W}_{Anchor}$$
$${O}_{\_ L} * sin ω + {O}_{\_ K} * cos ω = {l}_{Anchor}$$
in the equation, calculating W_{Anchor} according to the actual length of the length of the target frame in the world coordinate system, setting the lower left corner of the target frame as a point M and the lower right corner a point K so as to obtain coordinates of the point M and the point K in the pixel coordinate system as follows:
$${M}^{′} = ( {u}_{1} - \frac{Width}{2} - \frac{w}{2} , \frac{Hegiht}{2} - ( {v}_{1} + \frac{h}{2} ) ) \\ {K}^{′} = ( {u}_{1} - \frac{Width}{2} + \frac{w}{2} , \frac{Hegiht}{2} - ( {v}_{1} + \frac{h}{2} ) )$$
obtaining the world coordinate of the point M and the point K:
$$M = ( {X}_{m} , {Y}_{m} , {Z}_{m} ) \\ K = ( {X}_{k} , {Y}_{k} , {Z}_{k} )$$
thereby obtaining:
$${W}_{Anchor} = \vert {X}_{m} - {X}_{k} \vert$$
in the equation, O_{_L} and O_{_H} are obtained by simplifying
$$cos w = \sqrt{1 - {sin}^{2} w} ; ( {O}_{\_ L}^{2} + {O}_{\_ K}^{2} ) * {sin}^{2} w - 2 {O}_{\_ L} * {W}_{Anchor} sin w + ( {W}_{Anchor}^{2} - {O}_{\_ K} ) = 0$$
setting
$$a = {O}_{\_ L}^{2} + {O}_{\_ K}^{2} and b = - 2 {O}_{\_ L} * {W}_{Anchor} ,$$
and obtaining
$$b = - 2 {O}_{\_L} * {W}_{Anchor}$$
through a quadratic formula:
from
$$0 ° \leq ω \leq \frac{π}{2} ,$$
sin ω is a positive value:
$$sin ω = \vert \frac{- b \pm \sqrt{{b}^{2} - 4 a c}}{2 a} \vert \\ \\ ω = arc sin \vert \frac{- b \pm \sqrt{{b}^{2} - 4 a c}}{2 a} \vert$$
substituting ω into the equation, thereby obtain:
$${l}_{Anchor} = {O}_{\_ L} * sin ω + {O}_{\_ K} * cos ω .$$

8. The method for measuring the distance between the excavator and the high-voltage transmission line according to claim 7, wherein the height of the target object and the distance between the high-voltage transmission line and the target comprises, measuring the height of the high-voltage transmission line as
$${H}_{wrie}$$
by using the millimeter wave radar; according to the length O_{_L}, width O_{_K} and O_{_H} of the target after clustering, establishing a three-dimensional cube of the target; corresponding the point Q to the point G at the top of the target cube; connecting the optical center O_{c} with the point T to intersect a point S at the back of the cube; forming an included angle γ by O_{c}-T-S and the horizontal plane; and setting the length of GT as
$${h}_{x} ,$$
thereby obtaining the following equation according to the geometrical relationship:
$$tan γ = \frac{{h}_{x}}{{l}_{anchor}} \\ tan γ = \frac{H - h}{{D}_{OwQ} + {l}_{anchor}} \\ {h}_{object} = {h}_{Anchor} - h$$
wherein,
$${h}_{Anchor}$$
is the coordinate Z
$${D}_{OwQ} = \sqrt{{X}_{wQ}^{2} + {Y}_{wQ}^{2}}$$
of the point T in the world coordinate system, the height of the object is estimated by integrating the target position and the posture information, and thus the distance between the excavator and the high-voltage transmission line is further obtained:
$$distacnce = {H}_{wrie} - {h}_{object} .$$

9. A computer device, including a memory and a processor, wherein the memory is used for storing computer programs; and the steps of the method according to claim 8 are achieved when the computer programs are executed by the processor.

10. A computer readable storage medium, with computer programs stored thereon, wherein the steps of the method according to claim 8 are achieved when the computer programs are executed by the processor.
